(19) United States
(12) Patent Application Publication
(10) Pub. No.: US 2015/0066632 A1
(43) Pub. Date: Mar. 5, 2015

(54) SYSTEMS, METHODS, AND MEDIA FOR IMPROVING TARGETED ADVERTISING

(71) Applicant: VennScore LLC, Houston, TX (US)

(72) Inventors: Luis Gaston Gonzalez, Round Top, TX (US); Tiffany Latimer Gonzalez, Round Top, TX (US); Chance Michael Coble, Austin, TX (US)

(73) Assignee: VennScore LLC, Houston, TX (US)

(21) Appl. No.: 14/014,123

(22) Filed: Aug. 29, 2013

(51) Int. Cl. G06Q 30/02

(52) U.S. Cl. CPC G06Q 30/0255
USPC 705/14.45; 705/14.53

(57) ABSTRACT

Described are computer-based systems, computer-implemented methods, and non-transitory computer-readable media for improving the targeting of advertising in a publishing platform by utilizing payment card transaction data in concert with publisher data.

### BACKGROUND OF THE INVENTION

Online advertising uses the Internet to deliver promotional marketing messages to consumers. Like other advertising media, online advertising frequently involves both a publisher, who integrates advertisements into its online content, and an advertiser, who provides the advertisements to be displayed with the publisher's content. Online advertising includes email marketing, search engine marketing, social media marketing, many types of display advertising (including web banner advertising), as well as mobile advertising. Online advertising is widely used across industry sectors and is growing rapidly. In 2012, Internet advertising revenues in the United States totaled approximately $36.57 billion, a 15.2% increase over the $31.74 billion in revenues recognized in 2011.

A strength of online advertising is targeting. Publishers can offer advertisers the ability to reach customizable and narrow market segments for targeted advertising. This allows advertisers to customize each individual ad to a particular user based on the user's previous preferences. Targeted online advertising typically relies on optimization that combines available information about a user such as demographics with click-through behavior.

### SUMMARY OF THE INVENTION

In online advertising, each click is optionally used to reinforce the optimized associations that lead to improved targeting. However, a number of concerns have always surrounded this approach. For example, the fundamental statistical associations between user information and click-through behavior may not have an impact on purchasing behavior, which is often the ground truth the system is trying to optimize. Also, impression information is often difficult or impossible to value properly because click-through is often where user information is obtained and reported to the advertiser. Moreover, the purchasing behavior that does occur may not have a causal relationship to the offer or impression. Finally, some types of online ads are inherently difficult to evaluate in terms of effectiveness. For example, where a consumer is exposed a number of times to a banner ad for a particular brand of gasoline, current technologies do not offer an adequate way to measure any change in the consumer's offline behavior. In order to determine causation, the user's purchase behavior needs to be available to illustrate a change in behavior after the advertisement.

Credit card payments begin when the cardholder purchases a good or service through a merchant's point-of-sale (POS) system. The purchase information is transmitted to the merchant's bank in a typical scenario, which then transmits an authorization request through an interchange network and receives an authorization from the issuing bank. Assuming the account is in good standing to execute the purchase, the payment is authorized. Settlement for the transaction can occur later between the issuing bank and merchant's bank over the interchange network.

An interchange network is a central point of communication for many payment cards, and as a result, a resource for applications authorized by cardholders and merchants to take action on authorization, settlement, voiding or chargeback events. As an example, loyalty programs can operate over an interchange network for a specific merchant and cardholder by recognizing a certain cardholder transaction when the authorization or settlement occurs and applying an appropriate credit to the cardholder's account.

The subject matter disclosed herein resolves the deficiencies of the traditional methods by combining aspects of an advertising and publishing platform, a payment card system, and a software application aware of events on a set of interchange networks. In such a system, merchants and publishers are advantageously provided the ability to communicate more efficiently about campaign effectiveness. Cardholders are advantageously provided the ability to more effectively find offers and loyalty programs relevant for their interests and take advantage of loyalty programs associated directly with their payments cards. By monitoring interchange networks and issuing banks for payment card transaction data of activated payment cardholders known to have been exposed to particular advertising campaigns, the systems, media, and methods first described herein, dramatically improve the ability to target online advertising and measure the effectiveness of online advertising.

In one aspect, disclosed herein are non-transitory computer-readable storage media encoded with a computer program including instructions executable by a processor to create an application comprising: a software module configured to allow a publisher to create an advertising campaign, the advertising campaign comprising: one or more activated payment cardholders, the payment cardholders active on the publisher's platform, one or more merchants, and one or more advertisements; a software module configured to capture payment card transaction data associated with the payment cardholders, the payment card transaction data captured from an interchange network; and a software module configured to provide advertising targeting data for the campaign, the advertising targeting data ranked, the advertising targeting data optimized based on the payment card transaction data for the payment cardholders. In some embodiments, the advertising targeting data for the campaign comprises a measurement of campaign effectiveness. In some embodiments, the application further comprises a software module configured to allow registration of payment cardholders. In further embodiments, the application further comprises a software module configured to allow activation of payment cardholders. In some embodiments, the payment card is a credit card, debit card, prepaid card, charge card, membership card, promotional card, gift card, or frequent flyer card. In some embodiments, the payment card is a mobile processing device comprising a method of payment for performing a transaction. In some embodiments, the payment card transaction data comprises one or more of: merchant name, merchant contact information, merchant website, card capabilities, store name, store address, store contact information, store location, store website, store card capabilities, Standard Industry Categories (SICs), transaction status, transaction purchase date/time, transaction amount, transaction discount, transaction currency, user, and transaction card. In some embodiments, the advertising targeting data comprises SIC data. In some embodiments, the advertising targeting data comprises location data. In some embodiments, the payment cardholder information comprises information derived from a social network. In further embodiments, the advertising targeting data comprises an affinity determined by associations between users of the publisher's platform. In some embodiments, the application further comprises a software module configured to receive a request for advertising targeting data from a publisher, the request for a particular payment cardholder associated with the campaign. In some embodiments, the application further comprises a software module configured to receive a request for advertising targeting data from a publisher, the request for a particular group of payment cardholders associated with the campaign. In some embodiments, the application further comprises a software module configured to provide an analytics user interface, the analytics for an advertising campaign, the analytics incorporating payment card transaction data for the payment cardholders associated with the campaign. In further embodiments, the analytics user interface provides a measurement of advertisement effectiveness based on the payment card transaction data for the payment cardholders associated with the campaign. In further embodiments, the analytics user interface provides a degree of positive or negative trend acceleration for the payment card transaction data for the payment cardholders associated with the campaign. In further embodiments, the analytics user interface provides demographic information for payment cardholders associated with the campaign, the payment cardholders having payment card transaction data indicating response to the campaign. In some embodiments, the application further comprises a software module configured to allow a publisher to create an incentive campaign, the incentive campaign providing an incentive to a payment cardholder associated with a campaign, the incentive provided upon detection of payment card transaction data for a merchant associated with the campaign.

In another aspect, disclosed herein are computer-implemented systems comprising: a digital processing device comprising an operating system configured to perform executable instructions and a memory device; a computer program including instructions executable by the digital processing device to create an application comprising: a software module configured to allow a publisher to create an advertising campaign, the advertising campaign comprising: one or more activated payment cardholders, the payment cardholders active on the publisher's platform, one or more merchants, and one or more advertisements; a software module configured to capture payment card transaction data associated with the payment cardholders, the payment card transaction data captured from an interchange network; and a software module configured to provide advertising targeting data for the campaign, the advertising targeting data ranked, the advertising targeting data optimized based on the payment card transaction data for the payment cardholders. In some embodiments, the advertising targeting data for the campaign comprises a measurement of campaign effectiveness. In some embodiments, the application further comprises a software module configured to allow registration of payment cardholders. In further embodiments, the application further comprises a software module configured to allow activation of payment cardholders. In some embodiments, the payment card is a credit card, debit card, prepaid card, charge card, membership card, promotional card, gift card, or frequent flyer card. In some embodiments, the payment card is a mobile processing device comprising a method of payment for performing a transaction. In some embodiments, the payment card transaction data comprises one or more of: merchant name, merchant contact information, merchant website, card capabilities, store name, store address, store contact information, store location, store website, store card capabilities, SICs, transaction status, transaction purchase date/time, transaction amount, transaction discount, transaction currency, user, and transaction card. In some embodiments, the advertising targeting data comprises SIC data. In some embodiments, the advertising targeting data comprises location data. In some embodiments, the payment cardholder information comprises information derived from a social network. In some embodiments, the advertising targeting data comprises an affinity determined by associations between users of the publisher's platform. In some embodiments, the application further comprises a software module configured to receive a request for advertising targeting data from a publisher, the request for a particular payment cardholder associated with the campaign. In some embodiments, the application further comprises a software module configured to receive a request for advertising targeting data from a publisher, the request for a particular group of payment cardholders associated with the campaign. In some embodiments, the application further comprises a software module configured to provide an analytics user interface, the analytics for an advertising campaign, the analytics incorporating payment card transaction data for the payment cardholders associated with the campaign. In further embodiments, the analytics user interface provides a measurement of advertisement effectiveness based on the payment card transaction data for the payment cardholders associated with the campaign. In further embodiments, the analytics user interface provides a degree of positive or negative trend acceleration for the payment card transaction data for the payment cardholders associated with the campaign. In further embodiments, the analytics user interface provides demographic information for payment cardholders associated with the campaign, the payment cardholders having payment card transaction data indicating response to the campaign. In some embodiments, the application further comprises a software module configured to allow a publisher to create an incentive campaign, the incentive campaign providing an incentive to a payment cardholder associated with a campaign, the incentive provided upon detection of payment card transaction data for a merchant associated with the campaign.

In another aspect, disclosed herein are computer-implemented methods comprising: receiving, by a computer, configuration information from a publisher, the configuration information for an advertising campaign, the configuration information comprising: one or more activated payment cardholders, the payment cardholders active on the publisher's platform, one or more merchants, and one or more advertisements; capturing, by the computer, payment card transaction data associated with an activated payment cardholder, the payment card transaction data captured from an interchange network; and providing, by the computer, advertising targeting data for the campaign, the advertising targeting data comprising ranked SIC affinity or location affinity, the advertising targeting data optimized based on the payment card transaction data for the activated payment cardholder. In some embodiments, the advertising targeting data for the campaign comprises a measurement of campaign effectiveness. In some embodiments, the method further comprises providing an interface, by the computer, to allow configuration of an advertising campaign. In some embodiments, the method further comprises providing an interface, by the computer, to allow registration of payment cardholders. In some embodiments, the method further comprises providing an interface, by the computer, to allow activation of payment cardholders. In some embodiments, the payment card is a credit card, debit card, prepaid card, charge card, membership card, promotional card, gift card, or frequent flyer card. In some embodiments, the payment card is a mobile processing device comprising a method of payment for performing a transaction. In some embodiments, the payment card transaction data comprises one or more of: merchant name, merchant contact information, merchant website, card capabilities, store name, store address, store contact information, store location, store website, store card capabilities, SICs, transaction status, transaction purchase date/time, transaction amount, transaction discount, transaction currency, user, and transaction card. In some embodiments, the advertising targeting data comprises SIC data. In some embodiments, the advertising targeting data comprises location data. In some embodiments, the payment cardholder information comprises information derived from a social network. In further embodiments, the advertising targeting data comprises an affinity determined by associations between users of the publisher's platform. In some embodiments, the method further comprises receiving, by the computer, a request for advertising targeting data from a publisher, the request for a particular payment cardholder associated with the campaign. In some embodiments, the method further comprises receiving, by the computer, a request for advertising targeting data from a publisher, the request for a particular group of payment cardholders associated with the campaign. In some embodiments, the method further comprises providing, by the computer, an analytics user interface, the analytics for an advertising campaign, the analytics incorporating payment card transaction data for the payment cardholders associated with the campaign. In further embodiments, the analytics user interface provides a measurement of advertisement effectiveness based on the payment card transaction data for the payment cardholders associated with the campaign. In further embodiments, the analytics user interface provides a degree of positive or negative trend acceleration for the payment card transaction data for the payment cardholders associated with the campaign. In further embodiments, the analytics user interface provides demographic information for payment cardholders associated with the campaign, the payment cardholders having payment card transaction data indicating response to the campaign.

### BRIEF DESCRIPTION OF THE DRAWINGS

FIG. 1 shows a non-limiting example of a transaction flow for a demographic or category of payment cardholders; in this case, the subject matter described herein has identified a variance (see arrow) in typical transaction flow for a demographic or category of payment cardholders, using, for example, the 1st and 2nd derivative of the transaction frequency for that group, regression, or other statistical tests.

FIG. 2 shows a non-limiting example of a Venn diagram describing the subject matter described herein; in this case, a diagram depicting improved analysis of payment card transaction data by facilitating its secure enrichment with publisher data such as social media websites.

FIG. 3 shows a non-limiting example of a diagram depicting users in publisher data such as a social network; in this case, the diagram illustrates using the connections of demographic data and associating payment transactions with each user to provide improved context to understand behavior.

FIG. 4 shows a non-limiting example of a block diagram describing the subject matter described herein; in this case, a diagram depicting exemplary components and entities the interactions between them during activation and transaction processing.

FIG. 5 shows a non-limiting example of a graphic user interface (GUI) for presenting an advertising campaign dashboard; in this case, a dashboard for a publisher to demonstrate the reach of a campaign to advertisers.

FIG. 6 shows a non-limiting example of a GUI for presenting analytics data; in this case, a GUI for a publisher presenting analytics for the effectiveness of an advertising campaign including demographics data, payment card transaction data, and transaction acceleration data.

### DETAILED DESCRIPTION OF THE INVENTION

Described herein, in certain embodiments, are non-transitory computer-readable storage media encoded with a computer program including instructions executable by a processor to create an application comprising: a software module configured to allow a publisher to create an advertising campaign, the advertising campaign comprising: one or more activated payment cardholders, the payment cardholders active on the publisher's platform, one or more merchants, and one or more advertisements; a software module configured to capture payment card transaction data associated with the payment cardholders, the payment card transaction data captured from an interchange network and/or the issuing bank; and a software module configured to provide advertising targeting data for the campaign, the advertising targeting data ranked, the advertising targeting data optimized based on the payment card transaction data for the payment cardholders.

Also described herein, in certain embodiments, are computer-implemented systems comprising: a digital processing device comprising an operating system configured to perform executable instructions and a memory device; a computer program including instructions executable by the digital processing device to create an application comprising: a software module configured to allow a publisher to create an advertising campaign, the advertising campaign comprising: one or more activated payment cardholders, the payment cardholders active on the publisher's platform, one or more merchants, and one or more advertisements; a software module configured to capture payment card transaction data associated with the payment cardholders, the payment card transaction data captured from an interchange network and/or the issuing bank; and a software module configured to provide advertising targeting data for the campaign, the advertising targeting data ranked, the advertising targeting data optimized based on the payment card transaction data for the payment cardholders.

Also described herein, in certain embodiments, are computer-implemented methods comprising: receiving, by a computer, configuration information from a publisher, the configuration information for an advertising campaign, the configuration information comprising: one or more activated payment cardholders, the payment cardholders active on the publisher's platform, one or more merchants, and one or more advertisements; capturing, by the computer, payment card transaction data associated with an activated payment cardholder, the payment card transaction data captured from an interchange network and/or the issuing bank; and providing, by the computer, advertising targeting data for the campaign, the advertising targeting data comprising ranked SIC affinity or location affinity, the advertising targeting data optimized based on the payment card transaction data for the activated payment cardholder.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Overview

In the typical case, when goods or services are purchased with a payment card the purchase is authorized through an interchange network. In such cases, the amount of the transaction is verified from the merchant's point-of-sale (POS) system, through the merchant's bank, through the appropriate interchange network and finally to the issuing bank. If the transaction was approved and not voided, then at a later point the transaction is settled from the issuing bank through the interchange network to the merchant's bank. In some embodiments, the systems, methods, and media described herein utilize communications through the interchange network for a set of activated cardholders and a set of transactions.

### Payment Cards

In some embodiments, the systems, methods, and media described herein include payment cards, or use of the same. Many types of payment cards are suitable. In various embodiments, suitable payment cards include, by way of non-limiting examples, a credit card, a debit card, a prepaid card, a charge card, a membership card, a promotional card, a gift card, a frequent flyer card, and the like.

In some embodiments, a suitable payment card is a computer (including mobile devices, smart cards, personal digital assistants, and the like), which can be used as a method of payment for performing a transaction.

### Publishers

In some embodiments, the systems, methods, and media described herein include, or are used by, publishers. Many types of publishers are suitable. In some embodiments, suitable publishers include any content publishing or advertising platform. In various embodiments, suitable publishers include online social platforms such as, by way of non-limiting examples, social networks, professional networks, social media sharing applications, file sharing applications, and the like. In various embodiments, suitable publishers include online audio and video platforms such as, by way of non-limiting examples, Hulu, Vimeo, Netflix, internet radio, podcast platforms, digital music stores, and the like. In various embodiments, suitable publishers include book and periodical platforms such as, by way of non-limiting examples, e-book stores, self-publishing platforms, digital magazines, academic journals, news sites, and the like. In various embodiments, suitable publishers include television distribution networks such as, by way of non-limiting examples, cable television, satellite television, and the like. As an example, a publisher is typically a platform that presents targeted advertisements to users and optionally includes payment information for its users' payment cards. In the event a publisher has access to a payment card for its users and the necessary authority, then a publisher optionally registers and activates its users with the systems, methods, and media described herein.

### Advertizing Campaign

In some embodiments, the systems, methods, and media described herein include an advertising campaign, or use of the same. In further embodiments, a publisher configures an advertising campaign to be deployed on its platform for an advertiser by inputting parameters for the campaign. In some embodiments, the systems, methods, and media described herein include a software module configured to present a GUI to receive advertising campaign parameters from a publisher.

In some embodiments, an advertising campaign comprises user information. In further embodiments, the user information indicates the users or type/category of users to receive the advertisements. In other words, the user information indicates the users or type/category of users targeted by the advertising campaign. In some embodiments, individual users are identified. In other embodiments, a demographic category of users is identified. Many demographic parameters, known to the art, are suitable to identify users. In yet other embodiments, a connected network of users is identified.

In some embodiments, an advertising campaign comprises merchant information. In further embodiments, the merchant information indicates the merchant or type/category of merchants to be advertized to the users. In some embodiments, individual merchants are identified. In other embodiments, a universe of merchants is identified. In further embodiments, a plurality of merchants is identified based on one or more types of goods and/or services offered. In yet other embodiments, an affiliated network of merchants is identified.

In some embodiments, an advertising campaign comprises ad information. In further embodiments, the ad information indicates the ad(s) or type/category of ad(s) made available to the identified users. Many types of ads are suitable. In various embodiments, the ad information indicates that the ad is a banner ad, an expanding banner ad, an interstitial ad, a three-dimensional multimedia ad, a pre-roll ad, or a combination thereof. In further embodiments, the ad information indicates the messaging associated with one or more ads. In further embodiments, the ad information indicates the creative collateral associated with one or more ads. In further embodiments, the ad information indicates a discount, offer, coupon code, or the like associated with one or more ads. In some embodiments, the ad information indicates the number of ads or frequency of ads.

In some embodiments, the systems, methods, and media described herein include an incentive campaign, or use of the same. In further embodiments, an incentive campaign provides an incentive to a payment cardholder associated with a campaign, the incentive provided upon detection of payment card transaction data for a merchant associated with the campaign. In still further embodiments, a publisher configures an advertising incentive to be deployed on its platform for an advertiser by inputting parameters for the campaign. In some embodiments, the systems, methods, and media described herein include a software module configured to present a GUI to receive incentive campaign parameters from a publisher.

### Cardholders and Cardholder Data

In some embodiments, a publisher described herein offers user accounts. In further embodiments, a publisher requires a user to provide identifying information to activate an account. In further embodiments, a publisher acquires information regarding its users through the activities of users within the platform. In still further embodiments, user account information includes, by way of non-limiting examples, name, location, age, gender, address, connections (e.g., friends, links, etc.), payment card number, payment card type, payment card expiration, payment card billing address, and the like.

In some embodiments, the systems, methods, and media described herein maintain a set of registered (e.g., enrolled) cardholders in a database or set of databases as part of the system. In some embodiments, an enrolled cardholder must be activated in order to be included in the services provided by the invention. In further embodiments, activation is performed directly by a cardholder or by a platform of cardholders. In one example, an issuing bank enrolls cardholders by providing the information necessary to create activated cardholders. Alternatively, publishers perform the same enrollment and activation process for cardholders. These are only examples, in some embodiments, the subject matter described herein includes an interface for anyone with the authority and appropriate information to enroll and activate cardholders.

In some embodiments, the systems, methods, and media described herein are “opt-in.” In further embodiments, each user opts-in or agrees to the monitoring and collection of information pertaining to their account within a publishing platform and information pertaining to their use of payment card(s) for transactions. In some embodiments, a publisher acquires the “opt-in” of its users to participate. In further embodiments, a user opts-in as part of creating an account within a publishing platform. In other embodiments, a user opts-in as part of a dedicated agreement relating only to the systems, methods, media, and applications described herein.

In some embodiments, the systems, methods, and media described herein receive credit card transaction data for merchants and platforms from any type of payment (e.g., transaction) card described herein. The storage is optionally in a database or set of databases. In further embodiments, the system optionally accesses additional third party databases of transaction information to enrich the ranking and statistical associations between users, SIC, and/or locations.

In some embodiments, the systems, methods, and media described herein ranks SIC data for a user as well as locations when provided with a candidate user. In further embodiments, the invention ranks a list of SIC and location data, and associated with each user optionally applies inclusion/exclusion rules based on geographic region, SIC, and/or other information related to the merchant or merchant store. In some embodiments, the rankings are reinforced by the cardholder's purchasing activity. In various embodiments, the request and response for this ranking information is conducted over the Internet; however, any wide area network (WAN) is suitable.

The purchase behavior of cardholders at merchants often follows regular patterns. Deviation from regular patterns is interesting to merchants and advertisers, particularly if the deviation can be tied to impressions presented to the purchaser, or groups of purchasers. In publisher data, where users have the option to share their preferences a self-propagating change in activity can occur. In some embodiments, this rapid, or viral, growth is detected using the systems, methods, and media described herein for both an individual merchant, location, SIC, or even demographic. In further embodiments, this feature of the invention involves detecting when a business no longer fits a steady-state model. Many applications of statistics are optionally used to determine this, including tests based on first and second derivatives, regression functions, time series analysis, and mean deviation tests.

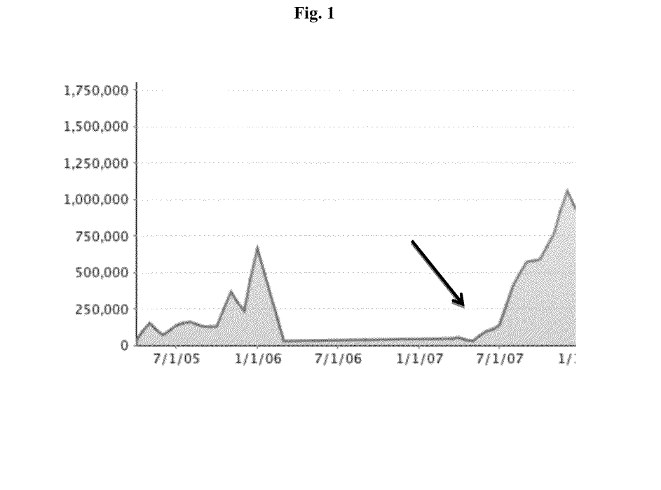

Referring to FIG. 1, in a particular embodiment, a transaction flow for a demographic or category of payment cardholders includes a variance (see arrow), which is detected by subject matter described herein using, for example, the 1st and 2nd derivative of the transaction frequency for that group.

### Card Transaction Data

Transaction data suitably includes a wide array of data about the purchase. For an example of suitably transaction data see Table 1. In some embodiments, transaction data holds information about products purchased or services provided. In further embodiments, a consequence of having at a minimum the merchant, amount, cardholder and time of transaction associated with the transaction is that any loyalty or incentive programs is optionally updated as part of the purchase event. For example, if a merchant wanted to offer a group of cardholders $5.00 off of their next purchase at a particular merchant then the merchant or publisher optionally creates that incentive using the systems, methods, and media described herein. In further embodiments, once the purchase occurs by a cardholder that accepted that incentive, the system will apply the $5.00 credit to the cardholders account and report the event to the publisher.

TABLE 1
Example data associated with a transaction

| Name | Description |
|---|---|
| Merchant Name | The name of the merchant or business accepting the purchase |
| Merchant Contact Information | The contact information of the merchant including any of |
| | email, phone, address, fax |
| Merchant Website | Website address for merchant |
| Card Capabilities | Cards accepted by business |
| Store Name | Merchant store name |
| Store Address | Street address of store, city, state, zip, country |
| Store Contact Information | The contact information of the store including any of |
| | email, phone, address, fax |
| Store Location | Latitude and longitude of the store |
| Store Website | Website address for store |
| Store card capabilities | Cards accepted at store |
| SIC | Standard Industry Category (SIC) associated with the store |
| Transaction status | Status of a transaction. |
| | Examples include indications that the transaction is |
| | authorized, settled, voided, etc. |
| Transaction purchase date/time | The date and time of the purchase |
| Transaction amount | The amount of the transaction |
| Transaction discount | The discount applied to the transaction |
| Transaction currency | Transaction currency |
| User | User associated with the transaction |
| Transaction Card | Card identifier associated with the transaction, and possibly |
| | the last 4 digits of the card |

### Results

In some embodiments, results of the systems, methods, and media described herein include more accurate targeting of advertising to users for the publisher through ranked SIC and/or location provided. In further embodiments, publishers optionally access reports and data products related to the users activated in the system, SIC affinity within a group of activated users, and even associate their own demographic information with the SIC and location affinity for users from the invention. In still further embodiments, the reports and data products include search functionality.

In one example application, this could be reified in a dashboard of reports, visualizations, and search functionality in which this affinity is reported, as are trends and patterns for populations and sub-populations of the publisher's users and their behavior on the publisher's platform as well as payment card activity. Such an example application provides additional decision support to the increased accuracy in advertisement targeting that the publisher receives.

In some embodiments, the publisher optionally makes such a dashboard available to merchants for the set of users and data that they would be entitled to analyze. In further embodiments, merchant dashboards enhance decision support, but for a set of questions related to that merchant's specific campaign and, for example, any demographics that may be relevant to their advertising interests. In still further embodiments, the publisher optionally makes variance and disparity in SIC, location, and/or demographics available in such an application to a merchant. In this example application, the merchant would likely be primarily interested in maximizing purchases driven to the various merchant stores through the increased targeting available on the publishing platform.

In some embodiments, the systems, methods, and media described herein combine payment card transaction data and publisher data. As an example, social networks have access to graphs of users of their systems and their relationships to others. In further embodiments, this information and the invention's data can be combined to advance targeting of advertising or better associate users with an offer. The graph that represents connected users in, for example, a social network, adds context to understanding purchasing behavior. Advertisements and offers are optionally limited to friends or friends of friends in a network. In some embodiments, the systems, methods, and media described herein offer a variety of options to rank users that are likely to convert.

Publishers, in some cases, obtain and store a wide array of information pertaining to their users. Many types of publisher information are suitable for use with the systems, methods, media, and applications described herein and suitable for use with payment card transaction data to measure and optimize ad targeting effectiveness. For example, in some embodiments, suitable publisher information includes basic user information. In further embodiments, basic user information includes, by way of non-limiting examples, name, username, password, and the like. In some embodiments, suitable publisher information includes user demographic information. In further embodiments, user demographic information includes, by way of non-limiting examples, age, generation, gender, employment status, employer, work address, profession, socioeconomic status, income, race, ethnicity, residential address, home ownership status, disabilities, languages, education, religion, and the like. In some embodiments, suitable publisher information includes user technology information. In further embodiments, user technology information includes, by way of non-limiting examples, computing device, device type, platform, operating system, browsing software, screen size, software versions, plug-in and extension information, network connectivity and speed information, and the like. In some embodiments, suitable publisher information includes user behavior information. In further embodiments, user behavior information includes, by way of non-limiting examples, applications accessed, web sites accessed, web pages viewed, duration of use/viewing, days of week in which a user accesses a publishing platform, times of day in which a user accesses a publishing platform, and the like. In some embodiments, suitable publisher information includes user social information. In further embodiments, user social information includes, by way of non-limiting examples, friends, connections, and associations within the platform, family members, and the like. In some embodiments, suitable publisher information includes user financial information. In further embodiments, user financial information includes, by way of non-limiting examples, savings account information, checking account information, payment card information, credit score, credit history, and the like.

Hand-in-hand with an enhanced ability to rank users is a deeper association between users (or their demographics) and merchants (or their SIC) and the passive evidence the user provides of their influenced behavior when purchasing using their payment card. The impact is similar to “check-in” style software which is popular on many mobile devices. However, in this case the user “checks-in” automatically by using their payment card. In some embodiments, the systems, methods, and media described herein allow a user to passively check-in to a specific location without having to take any additional action.

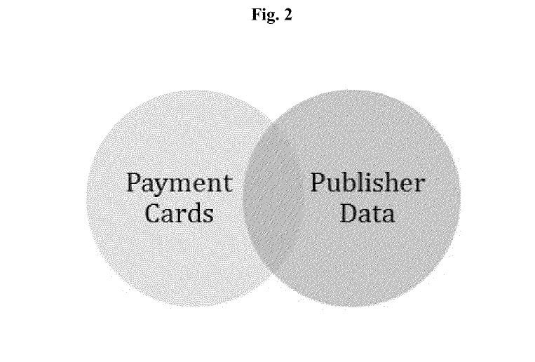

Referring to FIG. 2, a simple Venn diagram depicts improved analysis of payment card transaction data by facilitating its secure enrichment with publisher data.

In some embodiments, the combination of publisher data, for example a social network, and payment card data allow the systems, methods, and media described herein to identify influencers in the network. In further embodiments, influencers will be defined by their ability to create purchase behavior in other connected users. In such embodiments, the systems, methods, and media described herein estimate the conditional likelihood of an individual's association with a transaction event causing other individuals to engage a similar transaction because the purchase behavior can be mixed with the user data and social graph.

In some embodiments, this association provides the systems, methods, and media described herein with results users optionally take advantage of as well when searching for merchants or merchant types. In essence, the subject matter described herein optionally ranks merchants for the user, or creates a “halo” around merchants as part of a general merchant recommendation based on this combination of transaction and publisher data.

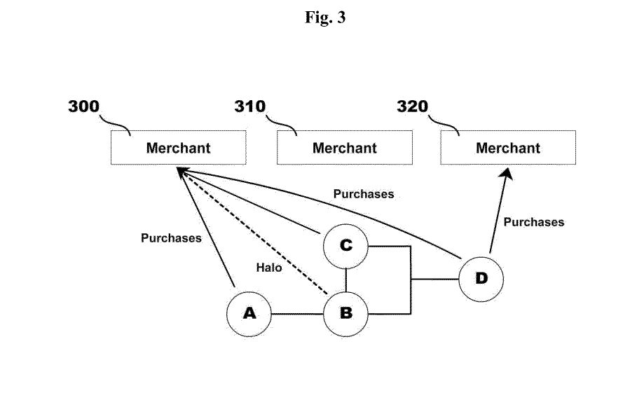

Referring to FIG. 3, in a particular embodiment, this “halo” is shown for a group of connected users. In this embodiment, user A is connected to user B, users B and C are connected to each other, and both are connected to user D. This information is known to the publisher operating the platform on which the users interact. A variety of merchants are available to the users 300, 310, and 320; however, each of users A, C, and D tend to favor transactions with a particular merchant 300. This information is known to the systems, media, and methods described herein by way of monitor one or more interchange networks and/or card issuing banks for the relevant payment card transition data. In this embodiment, by uniquely combining the publisher data with the payment card transaction data it is discovered that B has a strong association with the merchant 300 due to several direct connections having transactions associated with that merchant. As a result, advertising for merchant 300 is targeted to user B.

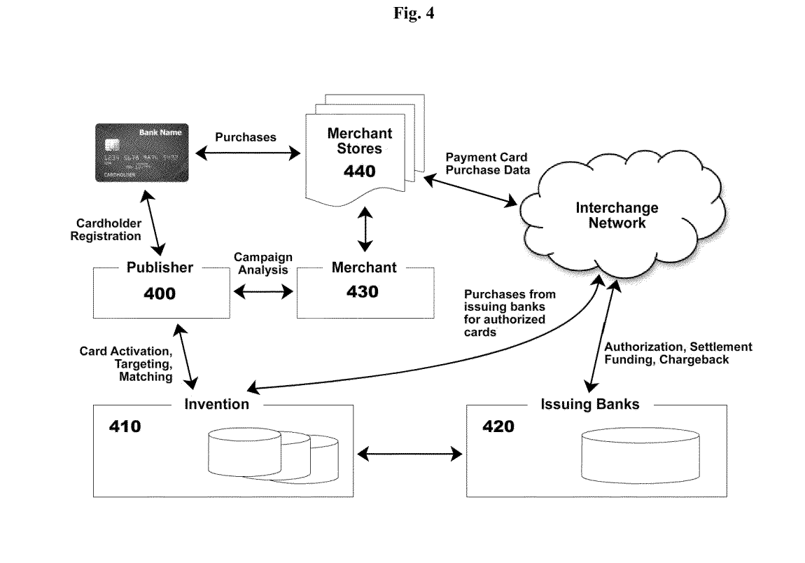

Referring to FIG. 4, in a particular embodiment, a publisher 400 has a known user base. The users make purchases, using payment cards, from merchant stores 440 and these merchants 430 buy advertising on the publisher's platform. The publisher is continually working with the merchants to perform campaign analysis to optimize the effectiveness of the ad campaigns. When a user makes a purchase at a merchant store 440, payment card purchase data is sent, via an interchange network, to the issuing bank 420 of the user's payment card. The issuing bank 420, in most cases, authorizes and eventually settles the transaction. The systems, media, and methods described herein 410 receive payment card purchase information from the interchange network and/or the issuing bank 420. This information is merged with publisher information to measure the real-world effectiveness of the advertising and to improve ad targeting. The publisher 400 uses analytics provided by the systems, media, and methods described herein 410 to refine the ad campaigns for the merchant advertising customers 430.

### Analytics

In some embodiments, the systems, methods, and media described herein include an analytics user interface, or use of the same. In further embodiments, the analytics user interface combines publisher data with payment card transaction data for the payment cardholders associated with a campaign. In still further embodiments, an analytics engine measures and evaluates advertising campaign reach and effectiveness, which is summarized and displayed by the analytics user interface. In particular embodiments, the analytics user interface is a publisher dashboard, an advertiser dashboard, or the like.

In some embodiments, an analytics user interface allows a publisher to request advertising targeting data for a particular payment cardholder, or a group/type of payment cardholders associated with a campaign. In further embodiments, the advertising targeting data comprises payment card transaction data pertaining to the merchants, goods, services, locations, offers, and the like associated with an advertising campaign.

In some embodiments, the advertising targeting data comprises affinity information for one or more SICs for the payment cardholder or group/type of payment cardholders associated with an advertising campaign. In still further embodiments, the SIC information is ranked. In particular embodiments, the affinities and rankings are optimized based on relevant payment card transaction information captured from one or more interchange networks or one or more payment card issuing banks.

In some embodiments, the advertising targeting data comprises affinity information for one or more locations for the payment cardholder or group/type of payment cardholders associated with an advertising campaign. In still further embodiments, the location information is ranked. In particular embodiments, the affinities and rankings are optimized based on relevant payment card transaction information captured from one or more interchange networks or one or more payment card issuing banks.

In some embodiments, the advertising targeting data comprises information derived from a social network, a professional network, a social media sharing network, a file sharing network, or the like, wherein connections between users is established. The media of claim 10, wherein the advertising targeting data comprises SIC and/or location affinity and/or ranking determined by associations between users of a publisher platform.

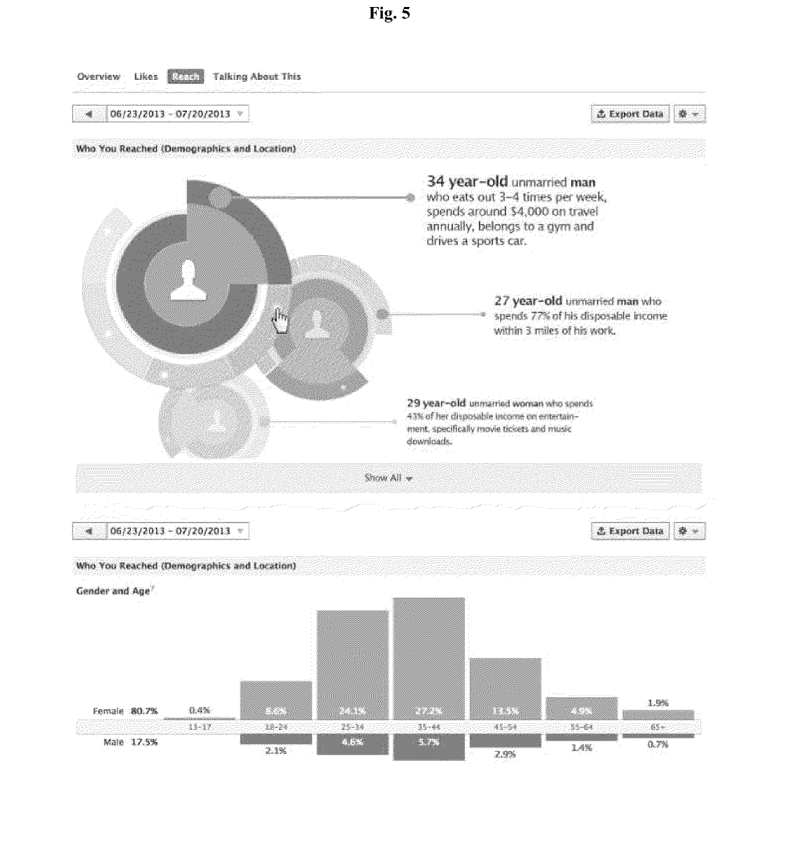

Referring to FIG. 5, in a particular embodiment, a publisher dashboard is adapted to allow a publisher to demonstrate the reach of advertising campaigns to current and potential advertisers. In this embodiment, the dashboard indicates users associated with a particular advertising campaign. Further in this embodiment, the dashboard identifies individuals who are influencers and provides their user information. The publisher dashboard also indicates a demographic breakdown of users associated with a particular advertising campaign by age and gender. In some embodiments, a publisher dashboard indicates users who have made relevant payment card transactions subsequent to exposure to an advertising campaign.

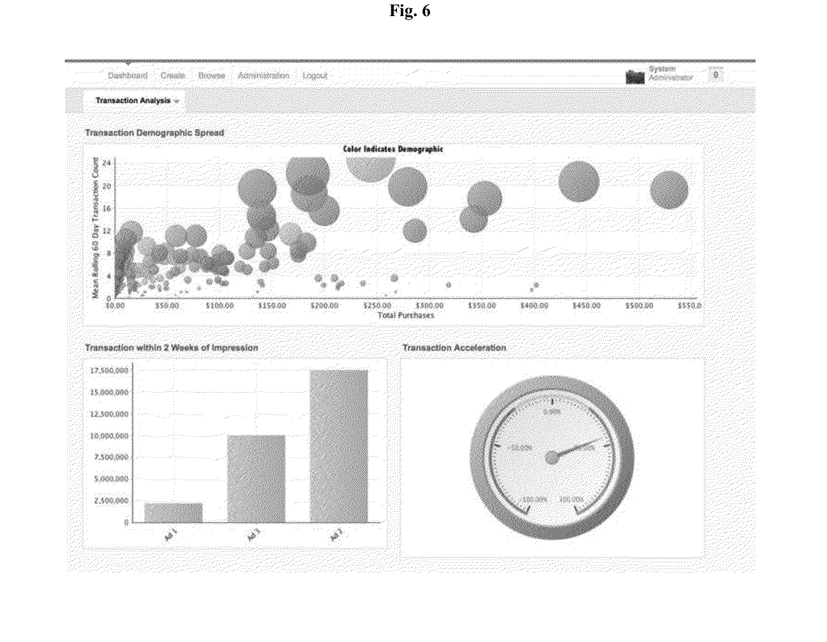

Referring to FIG. 6, in a particular embodiment, an analytics interface allows a publisher to access the effectiveness of an advertising campaign by incorporating publisher data with payment card transaction data for the payment cardholders associated with the campaign. In this embodiment, the analytics interface includes a demographic breakdown of users associated with the campaign based on the value of relevant purchases made during or after exposure to an advertising campaign. Further in this embodiment, the analytics interface includes a summary of the number of users making a relevant purchase within 2 weeks of an ad impression associated with an advertising campaign. In this case, the analytics interface also includes a graphic indicator of relevant transaction acceleration/deceleration trends.

In some embodiments, transaction trend detection functionality is utilized to alert publishers and advertisers to variance in transaction flow for a demographic or category of payment cardholders, using, for example, the 1st and 2nd derivative of the transaction frequency for that group, regression, or other statistical tests. See, e.g., FIG. 1.

### Digital Processing Device

In some embodiments, the systems, methods, and media described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the systems, methods, and media disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, methods, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the systems, methods, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, methods, and media disclosed herein include one or more databases, or use of the same. In view of the disclosure provided herein, those of skill in the art will recognize that many databases are suitable for storage and retrieval of, for example, user, purchase, demographic, and location information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Example

The following illustrative example is representative of an embodiment of the software applications, systems, and methods described herein and are not meant to be limiting in any way.

The first step for a user interaction is for a user to be activated. For the purpose of this example, a number of users for an online publisher have already been activated with payment cards. The invention stores these users, shares an identifier for each one with publishers, and maintains their status as activated when appropriate.

An activated user logs into the online publishing platform that is operated in the Seattle, Wash. area and begins looking at content available from the publisher. The publisher requests a ranking of locations and SIC's from the invention in order to determine accurately targeted advertising content for the user. The request includes the user the publisher intends to target and other activated users the publisher believes to be similar to the targeted user. The invention yields lists of SIC's and locations to the publisher, optimized by the user's purchase behavior. The optimized list of locations also includes regions outside of Seattle, Wash. because the user tends to visit other locations. The publisher elects to provide impressions of merchant X and merchant Y to the activated user.

At a later date, the activated user makes purchases at merchant X, but not merchant Y. The invention captures authorization and settlement events, and makes that information available to the publisher through callbacks and application programming interface (API) requests over the Internet. The invention's internal system is updated to provide optimized lists of the user's SIC's and locations for future requests.

The user logs into the publishing platform after their purchases and the publisher presents appropriate post-purchase messages to them. For example, the user may be involved in a loyalty program or the message may be a simple customer appreciation note from the merchant. The messages are enabled by the availability of authorization and settlement data for the example user as well as the associated merchant identifier. In addition to the authorization and settlement, the invention also notifies the publisher of a chargeback once that information becomes available on the interchange network of the transaction.

As the interaction progresses, the publisher's staff reviews the publishing application available with information from the invention. Useful features of the application include top ranking campaigns to demographic comparisons, disparity in purchasing locations for certain demographics, and variance in purchase behavior for certain demographics. Naturally, the range of intelligence that is provided in such an application goes far beyond this example.

Similarly, a merchant also optionally use an application specific to the campaign, purchase behavior, and cardholder actions that they are entitled to view. This result of the invention enables the merchant to analyze locations and demographics most associated with advertising success, and possibly also other locations, demographics and create an ability to search for cardholders that the merchant should target in advertisements. Merchants also optionally see location disparities in purchase behavior, as well as variance and trends in demographic, SIC, and location information.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. Non-transitory computer-readable storage media encoded with a computer program including instructions executable by a processor to create an application comprising:
a. a software module configured to allow a publisher to create an advertising campaign, the publisher offering a social networking, retail e-commerce, or media distribution, sharing, or discovery platform, the publisher's platform having a plurality of registered users, each user having a user profile in the platform, each user profile comprising user payment card, demographic, and social information, the advertising campaign for deployment on the publisher's platform, the advertising campaign comprising:
i. identification of one or more activated payment cardholders, the payment cardholders registered users on the publisher's platform,
ii. identification of one or more merchants, and
iii. identification of one or more advertisements;
b. a software module configured to capture payment card transaction data associated with the payment cardholders, the payment card transaction data captured from an interchange network; and
c. a software module configured to provide advertising targeting data for the campaign, the advertising targeting data optimized based on a plurality of locations and Standard Industrial Classifications (SICs) derived from the payment card transaction data for the payment cardholders, the locations and SICs sequentially ranked by strength of association with the payment card transaction data for the payment cardholders.

2. The media of claim 1, wherein the advertising targeting data for the campaign comprises a measurement of campaign effectiveness.

3. The media of claim 1, wherein the application further comprises a software module configured to allow registration of payment cardholders.

4. The media of claim 3, wherein the application further comprises a software module configured to allow activation of payment cardholders.

5. The media of claim 1, wherein the payment card is a credit card, debit card, prepaid card, charge card, membership card, promotional card, gift card, or frequent flyer card.

6. The media of claim 1, wherein the payment card is a mobile processing device comprising a method of payment for performing a transaction.

7. The media of claim 1, wherein the payment card transaction data comprises one or more of: merchant name, merchant contact information, merchant website, card capabilities, store name, store address, store contact information, store location, store website, store card capabilities, Standard Industry Categories, transaction status, transaction purchase date/time, transaction amount, transaction discount, transaction currency, user, and transaction card.

8. (canceled)

9. (canceled)

10. The media of claim 1, wherein the payment cardholder information comprises information derived from a social network.

11. The media of claim 10, wherein the advertising targeting data comprises an affinity determined by associations between users of the publisher's platform.

12. The media of claim 1, wherein the application further comprises a software module configured to receive a request for advertising targeting data from a publisher, the request for a particular payment cardholder associated with the campaign.

13. The media of claim 1, wherein the application further comprises a software module configured to receive a request for advertising targeting data from a publisher, the request for a particular group of payment cardholders associated with the campaign.

14. The media of claim 1, wherein the application further comprises a software module configured to provide an analytics user interface, the analytics for an advertising campaign, the analytics incorporating payment card transaction data for the payment cardholders associated with the campaign.

15. The media of claim 14, wherein the analytics user interface provides a measurement of advertisement effectiveness based on the payment card transaction data for the payment cardholders associated with the campaign.

16. The media of claim 14, wherein the analytics user interface provides a degree of positive or negative trend acceleration for the payment card transaction data for the payment cardholders associated with the campaign.

17. The media of claim 14, wherein the analytics user interface provides demographic information for payment cardholders associated with the campaign, the payment cardholders having payment card transaction data indicating response to the campaign.

18. The media of claim 1, wherein the application further comprises a software module configured to allow a publisher to create an incentive campaign, the incentive campaign providing an incentive to a payment cardholder associated with a campaign, the incentive provided upon detection of payment card transaction data for a merchant associated with the campaign.

19. A computer-implemented system comprising:
a. a digital processing device comprising an operating system configured to perform executable instructions and a memory device;
b. a computer program including instructions executable by the digital processing device to create an application comprising:
i. a software module configured to allow a publisher to create an advertising campaign, the publisher offering a social networking, retail e-commerce, or media distribution, sharing, or discovery platform, the publisher's platform having a plurality of registered users, each user having a user profile in the platform, each user profile comprising user payment card, demographic, and social information, the advertising campaign for deployment on the publisher's platform, the advertising campaign comprising: identification of one or more activated payment cardholders, the payment cardholders registered users on the publisher's platform, identification of one or more merchants, and identification of one or more advertisements;
ii. a software module configured to capture payment card transaction data associated with the payment cardholders, the payment card transaction data captured from an interchange network; and
iii. a software module configured to provide advertising targeting data for the campaign, the advertising targeting data optimized based on a plurality of locations and Standard Industrial Classifications (SICs) derived from the payment card transaction data for the payment cardholders, the locations and SICs sequentially ranked by strength of association with the payment card transaction data for the payment cardholders.

20. The system of claim 19, wherein the advertising targeting data for the campaign comprises a measurement of campaign effectiveness.

21. The system of claim 19, wherein the application further comprises a software module configured to allow registration of payment cardholders.

22. The system of claim 21, wherein the application further comprises a software module configured to allow activation of payment cardholders.

23. The system of claim 19, wherein the payment card is a credit card, debit card, prepaid card, charge card, membership card, promotional card, gift card, or frequent flyer card.

24. A computer-implemented method comprising:
a. receiving, by a computer, configuration information from a publisher, the configuration information for an advertising campaign, the publisher offering a social networking, retail e-commerce, or media distribution, sharing, or discovery platform, the publisher's platform having a plurality of registered users, each user having a user profile in the platform, each user profile comprising user payment card, demographic, and social information, the advertising campaign for deployment on the publisher's platform, the configuration information comprising:
i. identification of one or more activated payment cardholders, the payment cardholders registered users on the publisher's platform,
ii. identification of one or more merchants, and
iii. identification of one or more advertisements;
b. capturing, by the computer, payment card transaction data associated with an activated payment cardholder, the payment card transaction data captured from an interchange network; and
c. providing, by the computer, advertising targeting data for the campaign, the advertising targeting data optimized based on a plurality of locations and Standard Industrial Classifications (SICs) derived from the payment card transaction data for the activated payment cardholder, the locations and SICs sequentially ranked by strength of association with the payment card transaction data for the payment cardholders.

25. The method of claim 24, wherein the advertising targeting data for the campaign comprises a measurement of campaign effectiveness.

26. The method of claim 24, wherein the method further comprises providing an interface, by the computer, to allow configuration of an advertising campaign.

27. The method of claim 24, wherein the method further comprises providing an interface, by the computer, to allow registration of payment cardholders.

28. The method of claim 24, wherein the method further comprises providing an interface, by the computer, to allow activation of payment cardholders.

29. The method of claim 24, wherein the payment card is a credit card, debit card, prepaid card, charge card, membership card, promotional card, gift card, or frequent flyer card.
